(19) United States
(12) Patent Application Publication
(10) Pub. No.: US 2026/0339453 A1
(43) Pub. Date: Oct. 29, 2026

(54) DISPLAY APPARATUS

(71) Applicant: LG Display Co., Ltd., Seoul (KR)

(72) Inventors: HyunWoo JANG, Paju-si (KR); Sojung JUNG, Paju-si (KR); Minchul KIM, Paju-si (KR)

(73) Assignee: LG Display Co., Ltd., Seoul (KR)

(21) Appl. No.: 19/652,455

(22) Filed: Apr. 20, 2026

(30) Foreign Application Priority Data
Apr. 23, 2025 (KR) 10-2025-0052944

(51) Int. Cl. G06F 3/041

(52) U.S. Cl. CPC G06F 3/0416; G06F 3/0412

(57) ABSTRACT

A display apparatus according to an embodiment of the present disclosure comprises a touch detection part supplying touch driving signals to touch electrodes provided in a display panel, and analyzing touch sensing signals generated by touch electrode signals received from the touch electrodes to detect touch on the display panel; and a touch control part for changing a driving period of the touch detection part to an active period for determining a touch coordinate or a touch detection period for detecting a touch based on whether the display panel is touched, wherein the touch detection part generates a touch sensing signal by using touch electrode signals received from at least two touch electrodes during the touch detection period, stores only effective bit values among measurement bit values constituting the touch sensing signal, and detects a touch on the display panel by using the effective bit values.

### CROSS-REFERENCE TO RELATED APPLICATIONS

This application claims priority to Korean Patent Application No. 10-2025-0052944 filed in the Republic of Korea, on Apr. 23, 2025, the entirety of which is hereby incorporated by reference into the present application as if fully set forth herein.

### BACKGROUND

### Technical Field

The present disclosure relates to a display apparatus.

### Description of the Related Art

A display apparatus is mounted on or provided in electronic products such as televisions, monitors, notebook computers, smart phones, tablet computers, electronic pads, wearable devices, smart watch, portable information devices, navigation devices, or vehicle control display apparatus, etc., to display images.

For the user’s convenience, the display apparatus can be provided with touch electrodes capable of sensing a touch.

The driving period of the display apparatus including the touch electrodes can be divided into an active period for determining touch coordinates and a touch detection period for detecting touch.

In order to detect a touch in the touch detection period, touch sensing information have to be stored. In this case, in order to store all touch sensing information, a memory part having a memory area corresponding to the number of all touch sensing information have to be provided in the display apparatus.

Due to the increase in the size of the memory part, it can be difficult to miniaturize the display apparatus, and the manufacturing cost of the display apparatus can increase.

### BRIEF SUMMARY

Accordingly, the present disclosure is directed to providing a display apparatus that substantially obviates one or more problems due to limitations and disadvantages of the related art.

An aspect of the present disclosure is directed to providing a display apparatus which can store at least two touch sensing information in one memory area.

Additional advantages and features of the disclosure will be set forth in part in the description which follows and in part will become apparent to those having ordinary skill in the art upon examination of the following or can be learned from practice of the disclosure. The objectives and other advantages of the disclosure can be realized and attained by the structure particularly pointed out in the written description as well as the appended drawings.

To achieve these and other advantages and in accordance with the purpose of the disclosure, as embodied and broadly described herein, there is provided a display apparatus comprising a touch detection part supplying touch driving signals to touch electrodes provided in a display panel, and analyzing touch sensing signals generated by touch electrode signals received from the touch electrodes to detect touch on the display panel; and a touch control part for changing a driving period of the touch detection part to an active period for determining a touch coordinate or a touch detection period for detecting a touch based on whether the display panel is touched, wherein the touch detection part generates a touch sensing signal by using touch electrode signals received from at least two touch electrodes during the touch detection period, stores only effective bit values among measurement bit values constituting the touch sensing signal, and detects a touch on the display panel by using the effective bit values.

It is to be understood that both the foregoing general description and the following detailed description of the present disclosure are example and explanatory and are intended to provide further explanation of the disclosure as claimed.

### BRIEF DESCRIPTION OF THE SEVERAL VIEWS OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is an example diagram illustrating a configuration of a display apparatus according to an embodiment of the present disclosure;

FIG. 2 is an example diagram illustrating a structure of a pixel applied to a display apparatus according to an embodiment of the present disclosure;

FIG. 3 is an example diagram illustrating a structure of a control part applied to a display apparatus according to an embodiment of the present disclosure;

FIG. 4 is an example diagram illustrating structures of a display panel and a touch detection part applied to a display apparatus according to an embodiment of the present disclosure

FIG. 5 is an example diagram illustrating a structure of an r-th multiplexer included in a multiplexer part illustrated in FIG. 4;

FIG. 6 is an example diagram illustrating a structure of a memory part illustrated in FIG. 4;

FIG. 7 is a waveform diagram of signals applied to a display apparatus according to an embodiment of the present disclosure;

FIG. 8 is an example diagram illustrating a memory applied to a display apparatus according to an embodiment of the present disclosure;

FIG. 9 is another example diagram illustrating a memory applied to a display apparatus according to an embodiment of the present disclosure; and

FIG. 10 is another example diagram illustrating a memory applied to a display apparatus according to an embodiment of the present disclosure.

### DETAILED DESCRIPTION

Reference will now be made in detail to the example embodiments of the present disclosure, examples of which are illustrated in the accompanying drawings. Wherever possible, the same reference numbers will be used throughout the drawings to refer to the same or like parts.

Advantages and features of the present disclosure, and implementation methods thereof will be clarified through following embodiments described with reference to the accompanying drawings. The present disclosure can, however, be embodied in different forms and should not be construed as limited to the embodiments set forth herein. Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details. Like reference numerals refer to like elements throughout. In the following description, when the detailed description of the relevant known function or configuration is determined to unnecessarily obscure the important point of the present disclosure, the detailed description will be omitted. When “comprise,” “have,” and “include” described in the present disclosure are used, another part can be added unless “only” is used. The terms of a singular form can include plural forms unless referred to the contrary.

In construing an element, the element is construed as including an error or tolerance range although there is no explicit description of such an error or tolerance range.

In describing a position relationship, for example, when a position relation between two parts is described as, for example, “on,” “over,” “under,” and “next,” one or more other parts can be disposed between the two parts unless a more limiting term, such as “just” or “direct(ly)” is used.

In describing a time relationship, for example, when the temporal order is described as, for example, “after,” “subsequent,” “next,” and “before,” a situation that is not continuous can be included unless a more limiting term, such as “just,” “immediate(ly),” or “direct(ly)” is used.

It will be understood that, although the terms “first,” “second,” etc., can be used herein to describe various elements, these elements should not be limited by these terms. These terms are only used to distinguish one element from another. For example, a first element could be termed a second element, and, similarly, a second element could be termed a first element, without departing from the scope of the present disclosure.

In describing elements of the present disclosure, the terms “first,” “second,” “A,” “B,” “(a),” “(b),” etc., can be used. These terms are intended to identify the corresponding elements from the other elements, and basis, order, or number of the corresponding elements should not be limited by these terms. The expression that an element is “connected,” “coupled,” or “adhered” to another element or layer the element or layer cannot only be directly connected or adhered to another element or layer, but also be indirectly connected or adhered to another element or layer with one or more intervening elements or layers “disposed,” or “interposed” between the elements or layers, unless otherwise specified.

The term “at least one” should be understood as including any and all combinations of one or more of the associated listed items. For example, the meaning of “at least one of a first item, a second item, and a third item” denotes the combination of all items proposed from two or more of the first item, the second item, and the third item as well as the first item, the second item, or the third item. Also, the term “can” used herein can include all meanings and definitions of the term “may.”

Features of various embodiments of the present disclosure can be partially or overall coupled to or combined with each other, and can be variously inter-operated with each other and driven technically as those skilled in the art can sufficiently understand. The embodiments of the present disclosure can be carried out independently from each other, or can be carried out together in co-dependent relationship.

The present disclosure relates to a memory efficient touch sensing architecture that reduces storage requirements by selectively storing only effective bit values from touch sensing signals. Rather than storing all measurement bits, a subset of bits representing signal magnitude is retained to enable touch detection. In addition, multiple touch sensing signals are stored within a single memory area by dividing that memory into bit regions, which reduces memory size, hardware area, and associated cost.

The system further operates by aggregating signals from multiple electrodes and organizing electrodes into hierarchical groups. During a touch detection period, signals from multiple electrodes are combined into a single sensing signal, and multiple sensing results are stored within shared regions of a memory area such as upper and lower bit portions. The system also operates in two modes, including an active period for determining touch coordinates and a touch detection period for determining whether a touch is present, which allows m and lower power consumption during the detection period.

The architecture also allows adjustment of the number of stored bits and the selected bit ranges based on operating conditions. This enables control over the balance between sensing precision and resource usage. As a result, the overall approach provides reduced memory usage, lower power consumption, and flexible implementation while maintaining reliable touch detection performance.

Hereinafter, embodiments of the present disclosure will be described in detail with reference to the accompanying drawings.

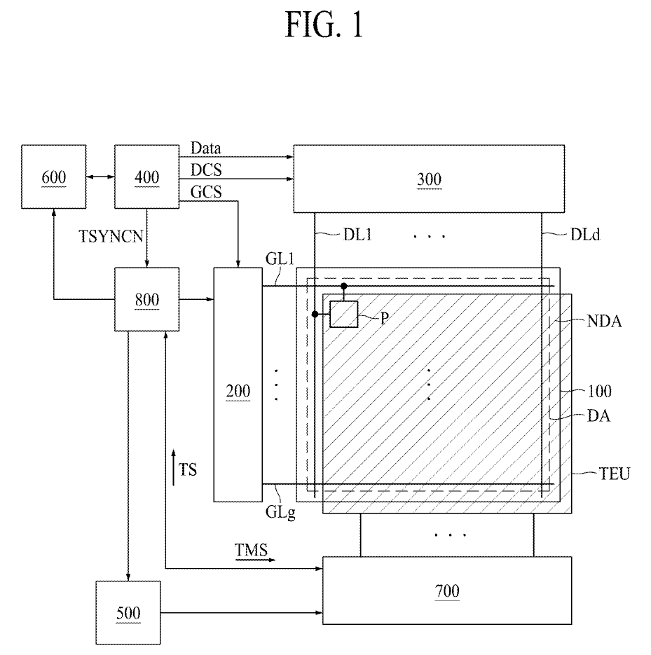

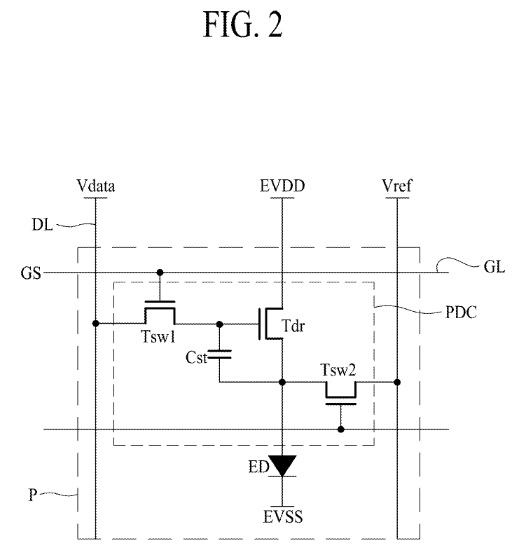

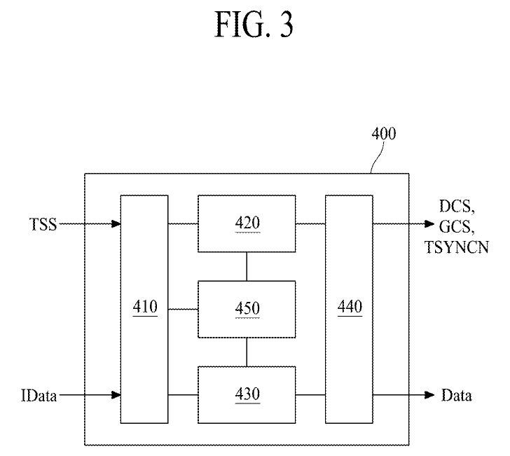

FIG. 1 is an example diagram illustrating a configuration of a display apparatus according to an embodiment of the present disclosure, FIG. 2 is an example diagram illustrating a structure of a pixel applied to a display apparatus according to an embodiment of the present disclosure, and FIG. 3 is an example diagram illustrating a structure of a control part applied to a display apparatus according to an embodiment of the present disclosure.

A display apparatus according to an embodiment of the present disclosure can be used in various kinds of electronic devices. Electronic devices can be, for example, televisions, monitors, etc.

The display apparatus according to an embodiment of the present disclosure, as illustrated in FIGS. 1 and 2, can include a display panel 100 which includes a display area DA displaying an image and a non-display area NDA provided outside the display area DA, a gate driver 200 which supplies gate signals GS to a plurality of gate lines GL1 to GLg provided in the display area DA of the display panel 100, a data driver 300 which supplies data voltages Vdata to a plurality of data lines DL1 to DLd provided in the display area DA of the display panel 100, a control part 400 which controls driving of the gate driver 200 and the data driver 300, a power supply part 500 which supplies power to the control part 400, the gate driver 200, the data driver 300, and the display panel 100, a touch electrode part TEU including touch electrodes, a touch detection part 700 that supplies touch driving signals to the touch electrode part TEU and detects a touch on the display panel 100 by using touch electrode signals received from the touch electrode part TEU, and a touch control part 800 that controls the operation of the touch detection part 700.

First, the display panel 100 can include a display area DA and a non-display area NDA. Gate lines GL1 to GLg, data lines DL1 to DLd, and pixels P can be provided in the display area DA. Accordingly, an image can be displayed in the display area DA. Here, g and d are natural numbers. The non-display area NDA can surround the outer periphery of the display area DA.

The pixel P included in the display panel 100, as illustrated in FIG. 2, can include a pixel driving circuit PDC which includes a switching transistor Tsw1, a storage capacitor Cst, a driving transistor Tdr, and a sensing transistor Tsw2, and a light emitting device ED connected to the pixel driving circuit PDC. That is, the display panel may be a light emitting display panel.

However, the display panel 100 may be a liquid crystal display panel including a liquid crystal.

That is, the display panel applied to the display apparatus according to an embodiment of the present disclosure may be any one of various types of display panels currently in use.

Next, the touch electrode part TEU can include touch electrodes.

The touch electrodes can be cathode electrodes included in a light emitting display panel or common electrodes included in a liquid crystal display panel. However, the touch electrodes can be separate electrodes independent of the cathode electrodes and the common electrodes.

Hereinafter, for convenience of description, a display apparatus in which cathode electrodes or common electrodes are used as touch electrodes is described as an example of a display apparatus according to an embodiment of the present disclosure.

In this case, the driving period of the display apparatus can be divided into a display period for displaying an image and a touch sensing period for sensing a touch.

In addition, the touch sensing period can be divided into an active period for determining touch coordinates and a touch detection period for detecting touch.

Next, the touch detection part 700 can supply touch driving signals to the touch electrode part TEU during the touch sensing period and detect a touch on the display panel 100 by using the touch electrode signals received from the touch electrode part TEU.

The touch detection part 700 can supply a cathode voltage or a common voltage to the touch electrode part TEU during the display period. Accordingly, an image can be displayed on the display panel during the display period.

Next, the touch control part 800 can control the operation of the touch detection part 700. To this end, the touch control part 800 can transmit a timing signal TMS related to the timing of outputting the touch driving signals to the touch detection part 700.

The touch control part 800 can generate touch coordinates of an area in which a touch is detected by using the touch signals TS transmitted from the touch detection part 700 and can transmit the generated touch coordinates to the external system 600. That is, the touch signal TS is a signal generated by the touch detection part 700, and the touch signal TS can include various pieces of information related to determining touch coordinates.

Next, the control part 400 can realign input data signals IData transmitted from an external system 600 by using a timing synchronization signal TSS transmitted from the external system and can generate a data control signal DCS which is to be supplied to the data driver 300 and a gate control signal GCS which is to be supplied to the gate driver 200.

To this end, as illustrated in FIG. 3, the control part 400 can include a data aligner 430 which realigns input data signals IData to generate data signal Data, a control signal generator 420 which generates the gate control signal GCS and the data control signal DCS by using the timing synchronization signal TSS, an input unit 410 which transmits the timing synchronization signal TSS transmitted from the external system 600 to the control signal generator 420 and transmits the input data signals IData transmitted from the external system 600 to the data aligner 430, and an output unit 440 which supplies the data driver 300 with the data signal Data generated by the data aligner 430 and the data control signal DCS generated by the control signal generator 420 and supplies the gate driver 200 with the gate control signal GCS generated by the control signal generator 420.

The control part 400 can further include a storage part for storing various kind of information. The storage part 450 can be included in the control part 400 as illustrated in FIG. 3, but can be separated from the control part 400 and provided independently.

The control part 400 can generate and transmit a touch synchronization signal TSYNCN for distinguishing the touch sensing period and the display period to the touch control part 800, and the touch control part 800 can transmit the touch synchronization signal TSYNCN to the touch detection part 700.

The external system 600 can perform a function of driving the control part 400 and an electronic device.

For example, when the electronic device is a television (TV), the external system 600 can receive various kinds of sound information and image information over a communication network and can transmit the received image information to the control part 400. For example, the external system 600 can convert the image information into input data signals IData and transmit the input data signals IData to the control part 400.

The external system 600 can control various functions of the electronic device by using touch coordinates transmitted from the touch control part 800.

Next, the power supply part 500 can generate various powers and supply the generated powers to the control part 400, the gate driver 200, the data driver 300, the display panel 100, the touch detection part 700, and the touch control part 800. For example, although FIG. 1 shows that the power supply part 500 is connected only to the touch detection part 700, the power supply part 500 can supply power to various components included in the display apparatus.

In addition, the power supply part 500 can generate a common voltage based on the power control signal transmitted from the touch control part 800 and transmit the common voltage to the touch detection part 700. In addition, the power supply part 500 can generate power used to generate the touch driving signal based on the power control signal and transmit the generated power to the touch detection part 700.

The common voltage can be supplied to the touch electrodes during the display period, and the touch driving signal can be supplied to the touch electrodes during the touch sensing period.

Next, the gate driver 200 can be directly embedded into the non-display area NDA by using a gate-in panel (GIP) type, or the gate driver 200 can be provided in the display area DA in which light emitting devices ED are provided, or the gate driver 200 can be provided on a chip on film mounted in the non-display area NDA.

The gate driver 200 can supply gate pulses to the gate lines GL1 to GLg.

For example, when a gate pulse generated by the gate driver 200 is supplied to a gate of the switching transistor Tsw1 included in the pixel P, the switching transistor Tsw1 can be turned on. When the switching transistor Tsw1 is turned on, data voltage Vdata supplied through a data line DL can be supplied to the pixel P.

When a gate-off signal generated by the gate driver 200 is supplied to the switching transistor Tsw1, the switching transistor Tsw1 can be turned off. When the switching transistor Tsw1 is turned off, a data voltage cannot be supplied to the pixel P any longer.

The gate signal GS supplied to the gate line GL can include the gate pulse and the gate-off signal.

To supply gate pulses GP1 to GPg to gate lines GL1 to GLg, the gate driver 200 can include stages connected to gate lines GL1 to GLg.

Each of the stages can be connected to one gate line GL, but can be connected to at least two gate lines GL.

In order to generate gate pulses, a gate start signal and at least one gate clock which are generated by the control signal generator 420 can be transferred to the gate driver 200. For example, the gate start signal and the at least one gate clock can be included in the gate control signal GCS.

One of the stages can be driven by a gate start signal VST to output a gate pulse to a gate line GL. The gate pulse can be generated by a gate clock.

At least one of signals output from a stage where a gate pulse is output can be supplied to another stage to drive another stage ST. Accordingly, a gate pulse can be output in another stage.

For example, the stages can be driven sequentially to sequentially supply the gate pulses to the gate lines GL.

Finally, the data driver 300 can supply data voltages Vdata to the data lines DL1 to DLd.

To this end, the data driver 300 can include a shift register which outputs a sampling signal, a latch which latches data signal Data received from the control driver 400, a digital-to-analog converter which converts the data signal Data, transmitted from the latch, into a data voltage Vdata and outputs the data voltage Vdata, and an output buffer which outputs the data voltage, transmitted from the digital-to-analog converter, to the data line DL based on a source output enable signal.

The data voltages Vdata supplied to the data lines DL1 to DLd can be supplied to pixels P connected to a gate line GL to which the gate pulse is supplied.

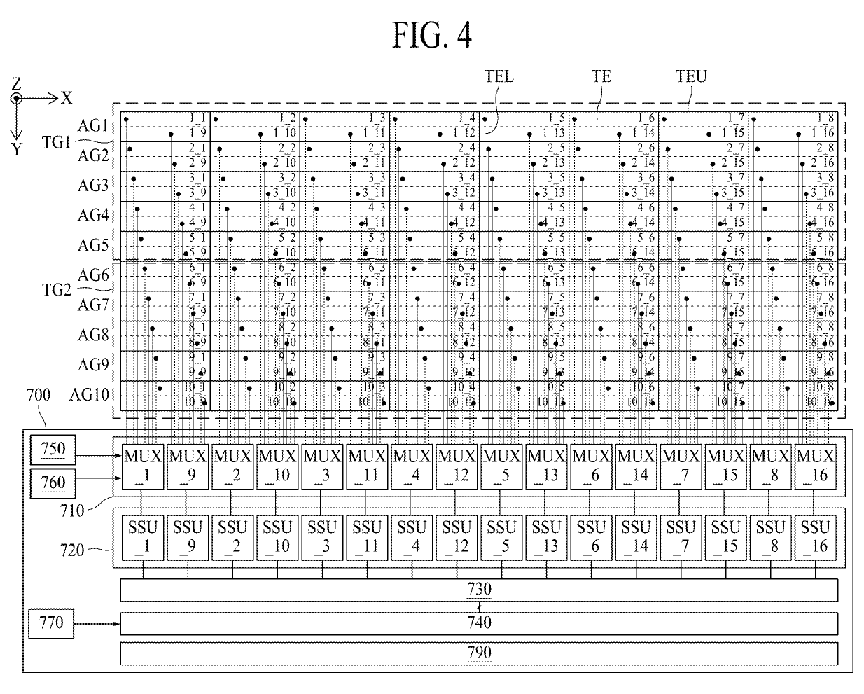

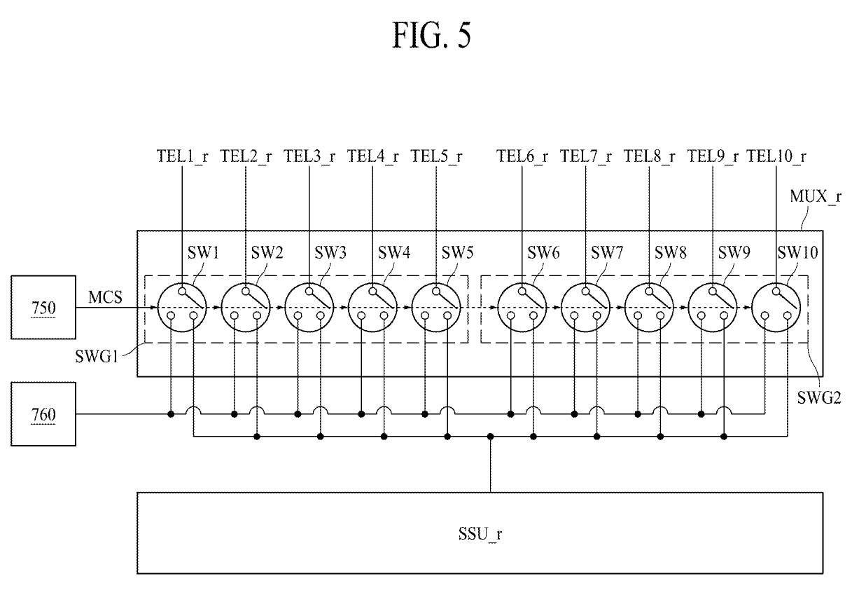

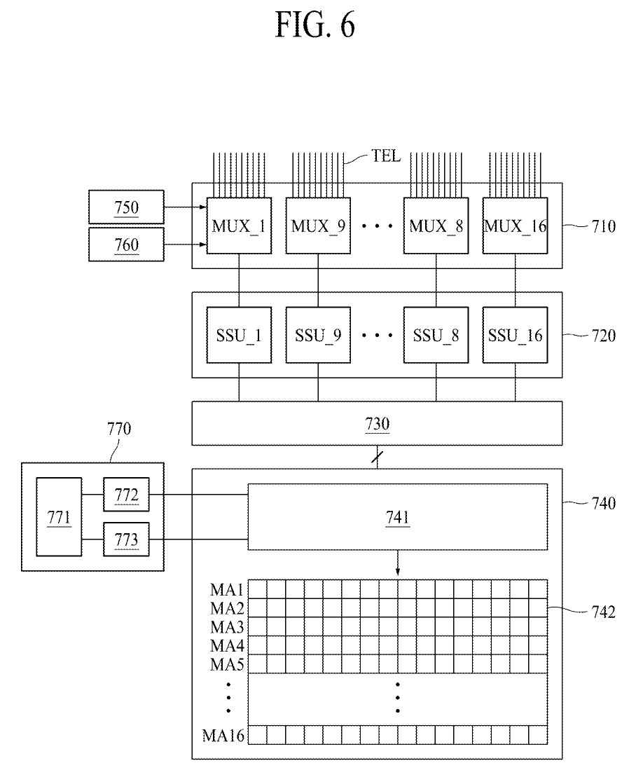

FIG. 4 is an example diagram illustrating structures of a display panel and a touch detection part applied to a display apparatus according to an embodiment of the present disclosure, FIG. 5 is an example diagram illustrating a structure of an r-th multiplexer included in a multiplexer part illustrated in FIGS. 4, and 6, is an example diagram illustrating a structure of a memory part illustrated in FIG. 4. In the following descriptions, contents that are the same as or similar to those described with reference to FIGS. 1-3 will be omitted or briefly described.

In order to detect a touch and determine a touch position, a display apparatus according to an embodiment of the present disclosure can include a touch electrode part TEU including touch electrodes TE, a touch detection part 700 that supplies a touch driving signal to the touch electrodes and detects a touch by using touch electrode signals transmitted from the touch electrodes TE, and a touch control part 800 that can generate a touch coordinate of an area in which a touch is detected by using touch signals TS transmitted from the touch detection part 700 and transmit the generated touch coordinate to the external system 600.

First of all, the terms to be used below are briefly defined as follows.

As described above, the driving period of the display apparatus can be divided into a display period for displaying an image and a touch sensing period for sensing a touch, and the touch sensing period can be divided into an active period for determining touch coordinates and a touch detection period for detecting touch.

During the active period, a touch can be detected, and touch coordinates of an area in which the touch is detected can be determined.

During the touch detection period, a touch can be detected, and touch coordinates are not determined.

For example, when a touch occurs, the touch detection part 700 and the touch control part 800 can be driven in an active period. Accordingly, a touch can be detected by the touch detection part 700, and the touch control part 800 can determine touch coordinates.

To this end, the touch detection part 700 can supply touch driving signals to the touch electrodes TE and detect a touch at the touch electrode part TEU by using touch electrode signals received from the touch electrodes TE. In this case, the touch control part 800 can determine the touch coordinates at the location where the touch is detected by analyzing the touch signal TS transmitted from the touch detection part 700. The touch signal TS can include information on whether a touch is detected and various information to be used for determining touch coordinates.

The touch coordinates can be transmitted to the external system 600, and the external system 600 can drive various application programs by using the touch coordinates.

When a touch is not continuously detected for a preset period in the active period, the touch detection part 700 and the touch control part 800 can perform functions corresponding to the touch detection period.

In the touch detection period, the touch detection part 700 can supply touch driving signals to the touch electrodes TE for touch detection and can detect a touch at the touch electrode part TEU by using touch electrode signals received from the touch electrodes TE.

In this case, the touch control part 800 can stop the operation for determining touch coordinates and can determine only whether a touch signal is transmitted from the touch detection part 700.

The touch signal can include a signal indicating that a touch is detected and information related to a location where the touch is detected.

Because the touch control part 800 does not perform an operation for determining touch coordinates, power consumption of the display apparatus in the touch detection period can be reduced.

In this case, the touch control part 800 can continuously receive the touch signals TS and analyze the touch signals TS to determine whether a touch is detected. In particular, during the touch detection period, the touch control part 800 can stop a function of determining touch coordinates and continuously perform a function of determining whether a touch is detected.

When it is determined that there is a touch as a result of analyzing the touch signal TS by the touch control part 800 during the touch detection period, the touch control part 800 and the touch detection part 700 can perform an operation in the active period. That is, the touch sensing period is switched from the touch detection period to the active period.

In the active period, the touch control part 800 can determine the touch coordinates by using the touch signals TS again.

That is, in the active period, the touch detection part 700 and the touch control part 800 can perform operations as described above, and accordingly, various application programs can be performed.

Next, the touch electrode part TEU can be provided in the display panel 100.

The touch electrode part TEU can include touch electrodes TE.

When the display panel 100 is a light emitting display panel including the light emitting devices ED, the cathode electrodes constituting the light emitting device can be used as the touch electrodes TE. Also, when the display panel 100 is a liquid crystal display panel including a liquid crystal, the common electrodes used for image display can be used as the touch electrodes TE.

Hereinafter, for convenience of description, an electrode used for image display and also used as a touch electrode TE is referred to as a common electrode, and a voltage supplied to a common electrode for image display is referred to as a common voltage. In this case, the voltage supplied to the common electrode (or touch electrode TE) for touch detection is referred to as a touch driving signal.

The touch electrodes TE can be divided into A active groups, and each of the A active groups can include B touch electrodes TE. Here, A can be a natural number of 4 or more, and B can be a natural number of 2 or more.

In the active period, touch driving signals can be simultaneously supplied to the touch electrodes TE included in the active group AG. Accordingly, touch detection operations for the touch electrodes TE included in the active group AG can be simultaneously performed.

For example, the touch electrode part TEU including 10 active groups AG1 to AG10 is illustrated in FIG. 4. That is, the touch electrode part TEU when A is 10 is illustrated in FIG. 4.

In addition, in the touch electrode part TEU shown in FIG. 4, each of the active groups AG1 to AG10 includes 16 touch electrodes TE. That is, in FIG. 4, the touch electrode part TEU when B is 16 is illustrated.

Hereinafter, when a specific example is needed, a display apparatus according to an embodiment of the present disclosure will be described by using the touch electrode part TEU shown in FIG. 4.

In this case, each of the 10 active groups AG1 to AG10 can include 16 touch electrodes TE.

Hereinafter, for convenience of description, reference numerals as shown in FIG. 4 can be assigned to the touch electrodes TE included in the 10 active groups AG1 to AG10.

For example, each of the active groups AG1 to AG10 can include 16 touch electrodes, as shown in FIG. 4, and the 16 touch electrodes TE can be disposed in a 2x8 form. Here, the 2x8 form can mean a structure in which two touch electrodes TE are disposed in the first direction (e.g., a Y-axis direction) and eight touch electrodes TE are disposed in a second direction (e.g., an X-axis direction) different from the first direction.

In this case, any one of 1 to 10 can be given to each of the touch electrodes TE included in the 10 active groups AG1 to AG10 provided along the first direction Y. For example, a reference numeral 1 can be given to the touch electrodes TE included in the first active group AG1, and a reference numeral 10 can be given to the touch electrodes TE included in the tenth active group AG10.

In addition, in each active group, eight touch electrodes TE arranged from the left to the right of the first row in the first direction Y can be sequentially given reference numerals 1 to 8, and reference numerals 9 to 16 can be sequentially given to the eight touch electrodes TE arranged from the left to the right of the second row in the first direction Y.

Accordingly, reference numerals 1_1 to 1_8 and 1_9 to 1_16 can be given to the touch electrodes TE included in the first active group AG1.

In addition, reference numerals 10_1 to 10_8 and 10_9 to 10_16 can be given to the touch electrodes TE included in the tenth active group AG10.

In the active period, a touch driving signal can be simultaneously supplied to the touch electrodes TE included in the first active group AG1, and accordingly, a touch can be detected in the touch electrodes TE included in the first active group AG1.

After, a touch driving signal can be simultaneously supplied to the touch electrodes TE included in the second active group AG1, and accordingly, a touch can be detected in the touch electrodes TE included in the second active group AG2.

The above-described operation can be sequentially performed for the third to tenth active groups AG3 to AG10, and accordingly, touches at the touch electrodes TE included in the third to tenth active groups AG3 to AG10 can be sequentially detected.

In the touch detection period, the touch detection part 700 can generate touch sensing signals by sequentially driving the C touch groups TG. Here, C can be a natural number of 2 or more.

In this case, each of the C touch groups TG can include at least two active groups AG.

In the touch detection period, touch driving signals can be simultaneously supplied to the touch electrodes TE included in the touch group TG. Accordingly, touch detection operations for the touch electrodes TE included in the touch group TG can be simultaneously performed.

For example, the touch electrode part TEU including two touch groups TG1 and TG2 is illustrated in FIG. 4. That is, the touch electrode part TEU when C is 2 is illustrated in FIG. 4.

In the touch detection period, a touch driving signal can be simultaneously supplied to the touch electrodes TE included in the first touch group TG1, and accordingly, a touch at the touch electrodes TE included in the first touch group TG1 can be detected.

After, a touch driving signal can be simultaneously supplied to the touch electrodes TE included in the second touch group TG2, and accordingly, a touch at the touch electrodes TE included in the second touch group TG2 can be detected.

Next, the touch detection part 700 supplies touch driving signals to the touch electrodes TE provided in the display panel 100 and analyzes touch sensing signals generated by touch electrode signals received from the touch electrodes TE to detect a touch on the display panel 100.

To this end, as shown in FIG. 4, the touch detection part 700 can include a multiplexer part 710, a touch electrode signal reception part 720, a conversion part 730, a memory part 740, a detection part 790, a timing control part 750, a common voltage generating part 760, and a memory control part 770. The multiplexer part 710 is connected to the touch electrodes TE and supplies touch driving signals or common voltages to the touch electrodes TE. The touch electrode signal reception part 720 supplies the touch driving signals to the touch electrodes TE through the multiplexer part 710 and receives touch electrode signals from the touch electrodes TE. The conversion part 730 converts the touch electrode signals transmitted from the touch electrode signal reception part 720 into touch sensing signals in a digital form. The memory part 740 stores touch sensing signals transmitted from the conversion part 730. The detection part 790 detects a touch in the touch electrode part TEU by using touch sensing signals stored in the memory part 740. The timing control part 750 generates multiplexer control signal MCS that controls the operation of the multiplexer part 710. The common voltage generating part 760 supplies a common voltage to the touch electrodes TE through the multiplexer part 710. The memory control part 770 controls the operation of the memory part 740.

The multiplexer part 710 can include a number of multiplexers MUX corresponding to the number B of touch electrodes TE included in the active group AG.

For example, the active group AG of the touch electrode part TEU shown in FIG. 4 includes 16 touch electrodes TE.

Therefore, as shown in FIGS. 4-6, the multiplexer part 710 can include 16 multiplexers MUX1 to MUX16.

In this case, each of the multiplexers can be connected to the number of touch electrode lines TEL corresponding to the number A of active groups AG.

For example, as shown in FIGS. 4-6, when the number A of active groups AG is 10, 10 touch electrode lines TEL are connected to each of the multiplexers MUX1 to MUX16.

In particular, a multiplexer MUX is connected to 10 touch electrodes TE provided at the same location in the active groups AG.

For example, as shown in FIG. 4, the first multiplexer MUX1 can be connected to the 1_1 touch electrode 1_1 provided at the upper left in the first active group AG1, the 2_1 touch electrode 2_1 provided at the upper left in the second active group AG2, the 3_1 touch electrode 3_1 provided at the upper left in the third active group AG3, the 4_1 touch electrode 4_1 provided at the upper left in the fourth active group AG4, the 5_1 touch electrode 5_1 provided at the upper left in the fifth active group AG5, the 6_1 touch electrode 6_1 provided at the upper left in the sixth active group AG6, the 7_1 touch electrode 7_1 provided at the upper left in the seventh active group AG7, the 8_1 touch electrode 8_1 provided at the upper left in the eighth active group AG8, the 9_1 touch electrode 9_1 provided at the upper left in the ninth active group AG9, and the 10_1 touch electrode 10_1 provided at the upper left in the 10th active group AG10.

In each of the first to tenth active groups AG1 to AG10, the second multiplexer MUX2 can be connected to the touch electrodes 1_2, 2_2, 3_2, 4_2, 5_2, 6_2, 7_2, 8_2, 9_2, and 10_2 provided at the second position from the upper left in the second direction X.

Each of the third to sixteenth multiplexers MUX3 to MUX16 can also be connected to the ten touch electrodes in the same manner as described above.

In this case, each of the multiplexers MUX can include 10 switches SW1 to SW10 connected to the 10 touch electrode lines TEL, as shown in FIG. 5.

For example, in FIG. 5, the r-th multiplexer MUX_r connected to the touch electrodes TE provided at the r-th position of each of the active groups AG1 to AG10 is illustrated. In this case, the ten switches SW1 to SW10 included in the r-th multiplexer MUX_r can be connected to the touch electrode lines TEL1_r to TEL10_r connected to the touch electrodes TE provided at the r-th position of each of the active groups AG1 to AG10.

Here, the (1_r)th touch electrode line TEL1_r refers to a touch electrode line connected to a touch electrode TE provided at the r-th position of the first active group AG1, and the (10_r)th touch electrode line TEL10_r refers to a touch electrode line connected to the touch electrode TE provided at the r-th position of the 10th active group AG10.

Here, the r-th position refers to any one of positions where the 16 touch electrodes TE included in the active group AG shown in FIG. 4 are disposed. For example, the first position can mean a position in which the first touch electrodes 1_1, 2_1, 3_1, …, and 10_1 are disposed among the 16 touch electrodes TE provided in each of the active groups AG, and the 16th position can mean a position in which the 16th touch electrodes 1_16, 2_16, 3_16, …, and 10_16 are disposed among the 16 touch electrodes TE provided in each of the active groups AG.

Each of the ten switches SW1 to SW10 included in the r-th multiplexer MUX_r can be connected to the common voltage generating part 760 to which the common voltage is supplied and the r-th reception part SSU_r. The r-th reception part SSU_r can be included in the touch electrode signal reception part 720.

Each of the ten switches SW1 to SW10 included in the r-th multiplexer MUX_r can be turned on or off by the multiplexer control signal MCS supplied from the timing control part 750.

Each of the 10 switches SW1 to SW10 included in the r-th multiplexer MUX_r can be sequentially driven according to the multiplexer control signal MCS during the active period to sequentially connect the touch electrode lines TEL1_r to TEL10_r to the touch electrode signal reception part 720 (especially the r-th reception part SSU_r).

Accordingly, in the active period, touch driving signals can be sequentially supplied to the active groups AG, and touches in the active groups AG can be sequentially detected.

When the touch electrodes TE are divided into two touch groups TG1 and TG2 as shown in FIG. 4, the ten switches SW1 to SW10 included in the r-th multiplexer MUX_r can also be divided into two switch groups SWG1 and SWG2.

In this case, the first switch group SWG1 includes switches SW1 to SW5 connected to the touch electrodes TE included in the first touch group TG1, and the second switch group SWG2 includes switches SW6 to SW10 connected to the touch electrodes included in the second touch group TG2.

For example, in the touch detection period, the five switches SW1 to SW5 included in the first switch group SWG1 can be simultaneously turned on by the multiplexer control signal MCS. When the five switches SW1 to SW5 included in the first switch group SWG1 are turned off, the five switches SW6 to SW10 included in the second switch group SWG2 can be simultaneously turned on by the multiplexer control signal MCS.

Accordingly, in the touch detection period, touches in the first touch group TG1 and the second touch group TG2 can be sequentially detected.

The touch electrode signal reception part 720 can include a number of reception parts SSU corresponding to the number B of touch electrodes TE included in the active group AG.

For example, the active group AG of the touch electrode part TEU shown in FIG. 4 includes 16 touch electrodes TE.

Therefore, as shown in FIGS. 4 and 6, the touch electrode signal reception part 720 can include 16 reception parts SSU_1 to SSU_16.

In this case, each of the 16 reception parts SSU_1 to SSU_16 can be connected to the 16 multiplexers MUX_1 to MUX_16 in a one-to-one manner.

Each of the reception parts SSU can supply a touch driving signal to at least one touch electrode TE through the multiplexer MUX and can receive a touch electrode signal transmitted through the multiplexer MUX. In FIG. 5, an r-th reception part SSU_r connected to the r-th multiplexer MUX_r is shown.

For example, in the active period, the touch driving signal transmitted from the r-th reception part SSU_r can be supplied to one touch electrode TE through the r-th multiplexer MUX_r. Also, the touch electrode signal transmitted from the touch electrode TE can be supplied to the r-th reception part SSU_r through the r-th multiplexer MUX_r.

In the touch detection period, the touch driving signal transmitted from the r-th reception part SSU_r can be supplied to at least two touch electrodes TE through the r-th multiplexer MUX_r. In addition, the touch electrode signal transmitted from at least two touch electrodes TE can be received to the r-th reception part SSU_r through the r-th multiplexer MUX_r.

For example, when the touch electrodes TE are divided into a first touch group TG1 and a second touch group TG2, the touch driving signal transmitted from the r-th reception part SSU_r can be supplied to the five touch electrodes TE included in the first touch group TG1 through the r-th multiplexer MUX_r. In addition, the touch electrode signal transmitted from the five touch electrodes TE included in the first touch group TG1 can be received to the r-th reception part SSU_r through the r-th multiplexer MUX_r.

Each of the reception parts SSU can transmit the touch electrode signal transmitted from the at least one touch electrode TE to the conversion part 730.

The conversion part 730 can convert the touch electrode signals transmitted from the reception part SSU into touch sensing signals in a digital form. That is, the conversion part 730 can perform a function of an analog-to-digital converter.

The memory part 740 stores the touch sensing signals transmitted from the conversion part 730. To this end, as shown in FIG. 6, the memory part 740 can include a memory 742 in which the touch sensing signal is stored and an alignment control part 741 for receiving the touch sensing signal transmitted from the conversion part 730 and storing the touch sensing signal in the memory 742 according to the memory control signal transmitted from the memory control part 770.

The alignment control part 741 can extract m measurement bit values among n bit values (hereinafter simply referred to as measurement bit values) constituting one touch sensing signal transmitted from the conversion part 730 according to the memory control signal and store them in the memory 742.

Here, n is a natural number, and m is a natural number less than or equal to 1/2 of n. Also, m measurement bit values can be effective bit values.

That is, the touch electrode signals received from at least two touch electrodes TE in the touch detection period are converted into one touch sensing signal in the conversion part 730, and the alignment control part 741 can store only m effective bit values among n measurement bit values constituting one touch sensing signal in the memory 742.

An operation of detecting a touch on the display panel by using effective bit values can be performed by the detection part 790.

Here, the effective bit values can include at least two upper area measurement bit values that affect the magnitude of the touch sensing signal among measurement bit values.

For example, the touch sensing signal can be displayed as binary bit values. In this case, a bit that has the greatest influence on the magnitude of the touch sensing signal among bits constituting the touch sensing signal is referred to as a most significant bit (MSB), and the MSB can be the leftmost bit among bits constituting the touch sensing signal. In the following description, a bit means a unit constituting a touch sensing signal, and a bit value means a specific value allocated to a bit.

In addition, among the bits constituting the touch sensing signal, the bits which is used for precise touch detection and precise touch position determination and is not significantly affect the magnitude of the touch sensing signal are called LSB (Least Significant Bits). LSB can be the rightmost bit among the bits constituting the touch sensing signal.

The effective bit values can mean values of bits that greatly influence the magnitude of the touch sensing signal, such as MSB.

For example, when the touch sensing signal is composed of n measurement bit values, n measurement bit values can include (n-1)th measurement bit values to zero-th measurement bit values, and effective bit values can include v-th measurement bit values to w-th measurement bit values. Here, v and w are natural numbers less than n, and w is a natural number less than v.

In addition, when the touch sensing signal consists of 16 bits and includes 16 measurement bit values, the 16 measurement bit values can include the 15th measurement bit value to the 0th measurement bit value. Here, the fifteenth measurement bit value means the value of the leftmost bit among the 16 bits constituting the measurement bit values, and the zero-th measurement bit value means the value of the rightmost bit among the 16 bits constituting the measurement bit values.

In this case, when the effective bit values include eight measurement bit values, the effective bit values can include a fifteenth to eighth measurement bit values.

In addition, when the effective bit values include six measurement bit values, the effective bit values can include the fifteenth to tenth measurement bit values.

In addition, when the effective bit values include four measurement bit values, the effective bit values can include the fifteenth to twelfth measurement bit values.

In this case, the effective bit values do not necessarily include MSB, for example, a fifteenth measurement bit value.

For example, when effective bit values include eight measurement bit values, effective bit values can include 15th to 8th measurement bit values, 14th to 7th measurement bit values, or 13th to 6th measurement bit values.

In addition, when effective bit values include six measurement bit values, effective bit values can include 15th to 10th measurement bit values, 14th to 9th measurement bit values, or 13th to 8th measurement bit values.

In addition, when effective bit values include four measurement bit values, effective bit values can include 15th to 12th measurement bit values, 14th to 11th measurement bit values, or 13th to 10th measurement bit values.

That is, the range of the measurement bits constituting the effective bit values can be variously changed according to the size of the touch sensing signal.

As described above, the alignment control part 741 can store only m effective bit values among n measurement bit values constituting the touch sensing signal in the memory 742.

In this case, the memory 742 can include a memory area MA including n bits. Effective bit values corresponding to at least two touch sensing signals can be stored in the memory area MA.

Also, the memory 742 can include B memory areas MA. B is the number of touch electrodes TE included in each of the active groups AG.

For example, as shown in FIG. 4, when each of the active groups AG includes 16 touch electrodes TE, the memory 742 can include 16 memory areas MA1 to MA16 as shown in FIG. 6.

The alignment control part 741 can store D touch sensing signals generated from all of the touch electrodes TE in B memory areas during the touch detection period. Here, D and B are natural numbers, B is a natural number smaller than D, and D is smaller than the number of touch electrodes provided in the display panel.

For example, as shown in FIG. 4, when the touch groups TG include the first touch group TG1 and the second touch group TG2, and each of the active groups AG includes 16 touch electrodes TE, 32 (when D is 32) touch sensing signals can be generated in the touch detection period. In addition, in the touch detection period, 16 touch sensing signals are generated by the first touch group TG1, and 16 touch sensing signals are generated by the second touch group TG2.

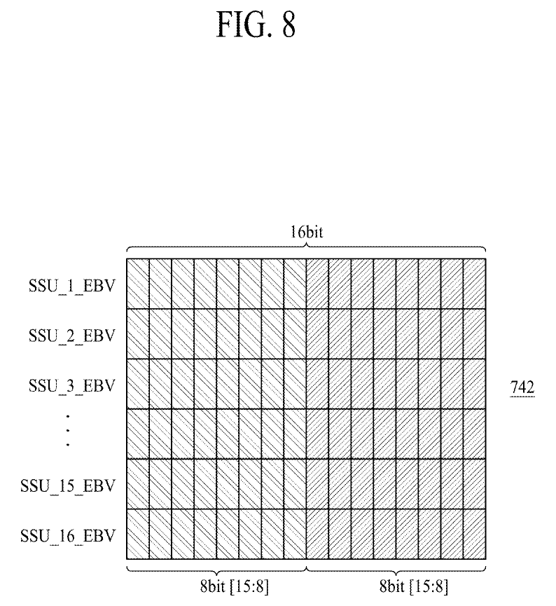

In this case, the alignment control part 741 can store 32 touch sensing signals in 16 memory areas. In particular, the alignment control part 741 can store 32 effective touch sensing signals corresponding to 32 touch sensing signals in 16 memory areas MA1 to MA16 (when B is 16). In this regard, it will be described in detail below with reference to FIG. 8.

Each of the effective touch sensing signals can include effective bit values as described above. In addition, some of the measurement bit values constituting the touch sensing signal can be effective bit values, and a signal including effective bit values can be a effective touch sensing signal.

In this case, as described above, the effective bit values can include eight bits, six bits, or four bits.

In addition, for example, when effective bit values include eight bits, effective bit values can include eight measurement bit values from the fifteenth measurement bit value, eight measurement bit values from the fourteenth measurement bit value, and eight measurement bit values from the thirteenth measurement bit value.

Also, for example, when effective bit values include four bits, effective bit values can include four measurement bit values from the fifteenth measurement bit value, four measurement bit values from the fourteenth measurement bit value, and four measurement bit values from the thirteenth measurement bit value.

The detection part 790 can detect a touch at the touch electrode part TEU by using touch sensing signals stored in the memory 742. In this case, as described above, effective bit values among measurement bit values constituting touch sensing signals are stored in the memory 742.

The timing control part 750 can generate the multiplexer control signal MCS for controlling the operation of the multiplexer part 710. According to the multiplexer control signal MCS, the multiplexers MUX can be controlled. Particularly, according to the multiplexer control signal MCS, the switches SW provided in each of the multiplexers MUX can be turned on or off.

The common voltage generating part 760 can generate a common voltage to be transmitted to the touch electrodes TE. In the active period, the common voltage generated by the common voltage generating part 760 can be supplied to the touch electrodes TE through the multiplexer part 710.

The memory control part 770 can generate a memory control signal. According to the memory control signal, the alignment control part 741 can store the touch sensing signal in the memory 742.

To this end, as shown in FIG. 4, the memory control part 770 can include a mode signal reception part 771 for receiving a mode signal from the touch control part 800, a first setting part 772 for setting the number of effective bit values to be stored in the memory area MA in the touch detection period based on the mode signal, and a second setting part 772 for setting a range of measurement bits constituting effective bit values based on the mode signal.

For example, the first setting part 772 can select whether to store 8 bits of effective bit values, 5 bits of effective bit values, or 4 bits of effective bit values.

In addition, when 8 bits of effective bit values are stored by the first setting part 772, the second setting part 773 can select whether to include measurement bit values starting from the 15th measurement bit value in the effective bit values, measurement bit values starting from the 14th measurement bit value in the effective bit values, or measurement bit values starting from the 13th measurement bit value in the effective bit values.

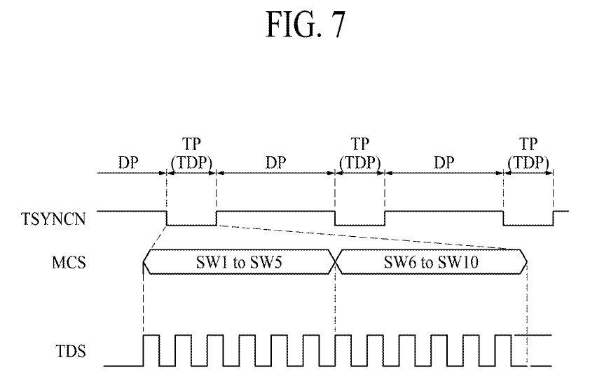

FIG. 7 is a waveform diagram of signals applied to a display apparatus according to an embodiment of the present disclosure, and FIG. 8 is an example diagram illustrating a memory applied to a display apparatus according to an embodiment of the present disclosure. In the following descriptions, contents that are the same as or similar to those described with reference to FIGS. 1-6 are omitted or briefly described. Also, hereinafter, the display apparatus according to the present disclosure is described using the display apparatus described with reference to FIGS. 4-6.

The control part 400 can generate a touch synchronization signal TSYNCN to distinguish between a display period DP in which images are displayed and a touch sensing period TP in which a touch is sensed and can transmit the touch synchronization signal TSYNCN to the touch control part 800. The touch control part 800 can transmit the touch synchronization signal TSYNCN to the touch detection part 700.

The touch control part 800 can analyze the touch signals TS transmitted from the touch detection part 800 for a preset touch sensing period TP before a current touch sensing period TP.

As a result of the analysis, if it is determined that there is a touch during the preset touch sensing period TP, the touch control part 800 can perform an operation corresponding to the active period and can transmit a mode signal indicating the active period to the mode signal reception part 771 of the touch detection part 700.

Accordingly, the touch detection part 700 can perform an operation corresponding to the active period.

For example, in the touch sensing period TP of the active period, the touch detection part 700 can sequentially turn on 10 switches SW1 to SW10 provided in each of the 16 multiplexers MUX1 to MUX16.

Accordingly, whether the presence of a touch in each of the first to tenth active groups AG1 to AG10 can be sequentially detected.

For example, when the switches SW connected to the first active group AG1 among the 10 switches SW1 to SW10 provided in each of the 16 multiplexers MUX1 to MUX16 are turned on, whether the first active group AG1 has a touch can be detected, and when the switches SW connected to the 10th active group AG10 among the 10 switches SW1 to SW10 provided in each of the 16 multiplexers MUX16 are turned on, whether the 10th active group AG10 has a touch can be detected.

In this case, touch detection for 10 active groups AG can be performed during one touch sensing period TP, or only touch detection for one active group AG can be performed during one touch sensing period TP.

As a result of analyzing the touch signals transmitted from the touch detection part 800 during the preset touch sensing period TP before the current touch sensing period TP, if it is determined that there is no touch during the preset touch sensing period TP, the touch control part 800 can perform an operation corresponding to the touch detection period and transmit a mode signal indicating the touch detection period TDP to the mode signal reception part 771 of the touch detection part 700.

Accordingly, the touch detection part 700 can perform an operation corresponding to the active period.

For example, when the touch detection period TDP starts, the touch control part 800 can transmit a mode signal indicating the start of the touch detection period TDP to the touch detection part 700 together with the touch synchronization signal TSYNCN.

The timing control part 750 receiving the mode signal indicating the start of the touch detection period TDP supplies a multiplexer control signal MCS capable of turning on only the switches SW connected to the same touch group TG among the switches SW provided in the multiplexers MUX to the multiplexer part 710.

For example, when the touch detection period TDP starts, the timing control part 750 turns on the first to fifth switches SW1 to SW5 connected to the first touch group TG1 among 10 switches SW1 to SW10 included in each of the multiplexers MUX, and supplies a multiplexer control signal MCS capable of turning off the sixth to tenth switches SW6 to SW10 connected to the second touch group TG2 to the multiplexer part 710.

In this case, the touch driving signal TDS generated from the touch electrode signal reception part 720 can be supplied to the touch electrodes TE included in the first touch group TG1 through the multiplexer part 710. The touch electrode signals generated from the touch electrodes TE included in the first touch group TG1 can be transmitted to the touch electrode signal reception part 720 through the multiplexer part 710, and the detection part 790 can detect a touch in the first touch group TG1 by using effective bit values generated by the touch electrode signals and stored in the memory 742.

When the touch electrode signals are received from the touch electrodes TE included in the first touch group TG1 to the touch electrode signal reception part 720 by the above process, the timing control part 750 turns off the first to fifth switches SW1 to SW5 connected to the first touch group TG1 among the 10 switches SW1 to SW10 included in each of the multiplexers, and supplies a multiplexer control signal MCS capable of turning on the sixth to tenth switches SW6 to SW10 connected to the second touch group TG2 to the multiplexer part 710.

In this case, the touch driving signal TDS generated from the touch electrode signal reception part 720 can be supplied to the touch electrodes TE included in the second touch group TG2 through the multiplexer part 710. The touch electrode signals generated from the touch electrodes TE included in the second touch group TG2 can be transmitted to the touch electrode signal reception part 720 through the multiplexer part 710, and the detection part 790 can detect a touch in the second touch group TG2 by using effective bit values generated by the touch electrode signal and stored in the memory 742.

In this case, the touch control part 800 can stop the function of determining the touch coordinates. Therefore, the power consumption of the touch control part 800 can be reduced.

However, in the touch detection period, the touch control part 800 can continuously analyze the touch signals TS transmitted from the touch detection part 700 to determine whether a touch has occurred.

When it is determined that there is a touch in the touch detection period TDS, the touch control part 800 can perform an operation of determining touch coordinates in the subsequent touch sensing period TP. That is, the subsequent touch sensing period TP can be the active period. Accordingly, the touch control part 800 and the touch detection part 700 can perform functions in the active period as described above.

Hereinafter, features related to effective bit values stored in memory 742 during the touch detection period TDS will be described with reference to FIGS. 4-8.

As described above, the touch electrodes TE included in the touch electrode part TEU are divided into A active groups AG (A is 10 in FIG. 4), and each of the A active groups AG includes B touch electrodes TE (B is 16 in FIG. 4).

In the touch detection period TDP, the touch detection part 700 generates touch sensing signals by sequentially driving the first touch group TG1 and the second touch group TG2. In this case, 16 touch sensing signals are generated by the first touch group TG1 and 16 touch sensing signals are generated by the second touch group TG2.

Each of the first touch group TG1 and the second touch group TG2 includes A/2 active groups AG. For example, when A is 10 as shown in FIG. 4, each of the first touch group TG1 and the second touch group TG2 can include five active groups AG.

The touch detection part 700 can store the B touch sensing signals generated in the first touch group TG1 in the upper areas of the B memory areas MA, and the touch detection part 700 can store the B touch sensing signals generated in the second touch group TG2 in the lower areas of the B memory areas MA.

Here, the upper areas can mean bits provided on the left side of the bits constituting the memory area MA, and the lower area can mean bits provided on the right side of the bits constituting the memory area MA.

For example, the touch detection part 700 can store 16 touch sensing signals generated in the first touch group TG1 in the upper areas of the 16 memory areas MA1 to MA16.

In this case, the 16 touch sensing signals can mean 16 effective touch sensing signals generated by the alignment control part 741, and each of the 16 effective touch sensing signals can include effective bit values as described above.

In addition, the touch detection part 700 can store the 16 effective touch sensing signals SSU_1_EBV to SSU_16_EBV generated in the first touch group TG1 in eight bits provided on the left side of the 16 memory areas MA1 to MA16, as shown in FIG. 8.

In addition, the touch detection part 700 can store 16 effective touch sensing signals (SSU_1_EBV to SSU_16_EBV) generated in the second touch group TG2 in eight bits provided on the right side of the 16 memory areas MA1 to MA16, as shown in FIG. 8.

To provide an additional description, the touch detection part 700 can store m upper area measurement bit values among n measurement bit values (n is a natural number and m is a natural number less than or equal to 1/2 of n) in the first area of the memory area. In this case, the number of bits in the first area can be less than the number of bits in the memory area MA.

For example, the touch detection part 700 can store eight upper area measurement bit values among 16 measurement bit values corresponding to the first touch sensing signal generated by the first touch group TG1 in the first area of the first memory area MA1. Here, the eight upper area measurement bit values can mean bit values corresponding to bits that can affect the magnitude of the touch sensing signal, as described above. Also, the first area can mean eight bits provided on the left side of the first memory area MA1, as shown in FIG. 8.

In this case, the touch detection part 700 can store eight upper area measurement bit values among 16 measurement bit values corresponding to the second touch sensing signal generated by the second touch group TG2 in the second area of the first memory area MA1. Here, the second area can mean eight bits provided on the right side of the first memory area MA1, as shown in FIG. 8.

For example, the touch detection part can store m measurement bit values among n measurement bit values of the first touch sensing signal in the first area of the first memory area MA1, and store m measurement bit values among n measurement bit values of the second touch sensing signal in the second area of the first memory area MA1.

In this case, the first area can be an upper area of the first memory area MA1, and the second area can be a lower area of the first memory area MA2.

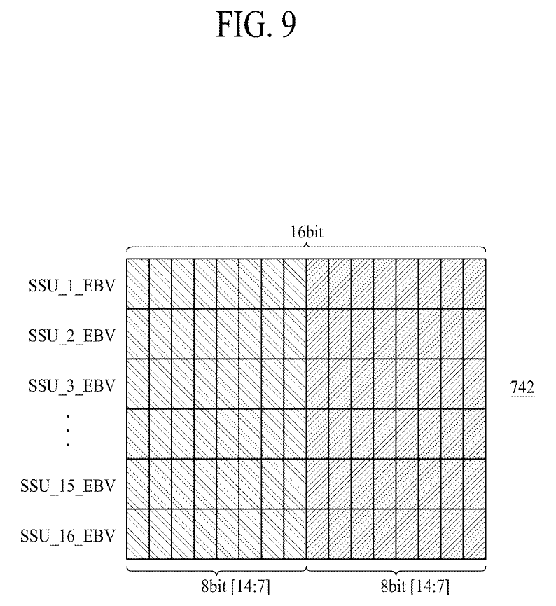

FIG. 9 is another example diagram illustrating a memory applied to a display apparatus according to an embodiment of the present disclosure. In the following descriptions, contents that are the same as or similar to those described with reference to FIGS. 1-8 will be omitted or briefly described.

As described above, when effective bit values include eight measurement bit values, effective bit values can include 15th to 8th measurement bit values, 14th to 7th measurement bit values, or 13th to 6th measurement bit values.

For example, in the example shown in FIG. 8, each of the effective touch sensing signals SSU_1_EBV to SSU_16_EBV generated in the first touch group TG1 can include a fifteenth measurement bit value to an eighth measurement bit value [15:8], and each of the effective touch sensing signals SSU_1_EBV to SSU_16_EBV generated in the second touch group TG2 can include a fifteenth measurement bit value to an eighth measurement bit value [15:8].

In this case, the effective touch sensing signals generated in the first touch group TG1 can be stored in the left area (or the first area or the upper area) of the memory areas MA1 to MA16. In addition, the effective touch sensing signals generated in the second touch group TG2 can be stored in the right area (or the second area or lower area) of the memory areas MA1 to MA16.

However, in the example shown in FIG. 9, each of the effective touch sensing signals SSU_1_EBV to SSU_16_EBV generated in the first touch group TG1 can include a fourteenth measurement bit value to a seventh measurement bit value [14:7], and each of the effective touch sensing signals SSU_1_EBV to SSU_16_EBV generated in the second touch group TG2 can include a fourteenth measurement bit value to a seventh measurement bit value [14:7].

In this case, the effective touch sensing signals generated in the first touch group TG1 can be stored in the left area (or a first area or an upper area) of the memory areas MA1 to MA16. In addition, the effective touch sensing signals generated in the second touch group TG2 can be stored in the right area (or a second area or a lower area) of the memory areas MA1 to MA16.

To provide an additional description, when the measurement bit values include the (n-1)th measurement bit value to the zero-th measurement bit value, and the effective bit values include the v-th measurement bit value to the w-th measurement bit value (v and w are natural numbers less than n, and w is natural numbers less than v), the touch detection part 700 can store the effective bit values of the B touch sensing signals generated in the first touch group TG1 in the upper areas of the B memory areas, and the touch detection part 700 can store the effective bit values of the B touch sensing signals generated in the second touch group TG2 in the lower areas of the B memory areas MA.

For example, when measurement bit values include 15th to 0th measurement bit values and effective bit values include 14th to 7th measurement bit values, the touch detection part 700 can store the effective bit values of 16 touch sensing signals (effective touch sensing signals) generated in the first touch group TG1 in the upper areas (or first areas) of the 16 memory areas, and the touch detection part 700 can store the effective bit values of 16 touch sensing signals (effective touch sensing signals) generated in the second touch group TG2 in the lower areas of the B memory areas MA.

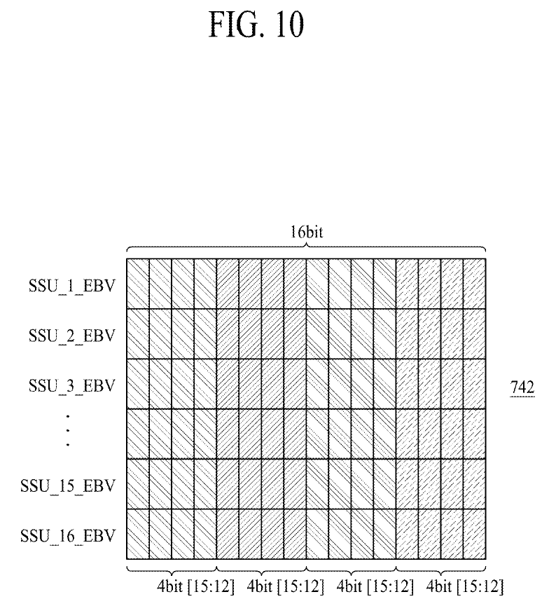

FIG. 10 is another example diagram illustrating a memory applied to a display apparatus according to an embodiment of the present disclosure. In the following descriptions, contents that are the same as or similar to those described with reference to FIGS. 1-9 are omitted or briefly described.

As described above, when effective bit values include eight measurement bit values, effective bit values can include a fifteenth measurement bit value to an eighth measurement bit value, when effective bit values include six measurement bit values, effective bit values can include a fifteenth measurement bit value to a tenth measurement bit value, and when effective bit values include four measurement bit values, effective bit values can include a fifteenth measurement bit value to a twelfth measurement bit value.

For example, in FIGS. 8 and 9, an example, in which when effective bit values include eight measurement bit values, the effective touch sensing signals SSU_1_EBV to SSU_16_EBV of the first touch group TG1 are stored in the first area (or upper area or left area) of one memory area MA, and the effective touch sensing signals SSU_1_EBV to SSU_16_EBV of the second touch group TG2 are stored in the second area (or lower area or right area), is shown.

In this case, the touch electrode part TEU can be divided into a first touch group TG1 and a second touch group TG2, as shown in FIG. 4. Touch detection for the first touch group TG1 and touch detection for the second touch group TG2 can be performed during one touch detection period TDP, as shown in FIG. 7.

For example, during one touch detection period TDP, the multiplexer control signal MCS capable of turning on the first to fifth switches SW1 to SW5 and the multiplexer control signal MCS capable of turning on the sixth to tenth switches SW6 to SW10 can be sequentially supplied to the multiplexer part 710. Accordingly, the effective touch sensing signals SSU_1_EBV to SSU_16_EBV of the first touch group TG1 and the effective touch sensing signals SSU_1 to SSU_16_EBV of the second touch group TG2 can be sequentially stored in the memory 742.

However, during the touch detection period TDP, the multiplexer control signal MCS capable of turning off the first to fifth switches SW1 to SW5 can be transmitted to the multiplexer part 710, and during another touch detection period TDP, the multiplexer control signal MCS capable of turning on the sixth to tenth switches SW6 to SW10 can be supplied to the multiplexer part 710. Accordingly, the effective touch sensing signals SSU_1_EBV to SSU_16_EBV of the first touch group TG1 and the effective touch sensing signals SSU_1_EBV to SSU_16_EBV of the second touch group TG2 can be sequentially stored in the memory 742.

Also, when the touch electrode part TEU is divided into four touch groups, the effective bit values can include four measurement bit values, as shown in FIG. 10. That is, the effective bit values can consist of four bits.

In this case, touch detections for the first to fourth touch groups can be performed during one touch detection period TDP.

For example, during one touch detection period TDP, a multiplexer control signal MCS capable of turning on the first to third switches SW1 to SW3, an multiplexer control signal MCS capable of turning on the fourth to fifth switches SW4 to SW5, an multiplexer control signal MCS capable of turning on the sixth to eighth switches SW6 to SW8, and an multiplexer control signal MCS capable of turning on the ninth to tenth switches SW9 to SW10 can be sequentially supplied to the multiplexer part 710.

Accordingly, the effective touch sensing signals SSU_1_EBV to SSU_16_EBV of the first touch group TG1 can be stored in the first area of the memory areas MA1 to MA16, the effective touch sensing signals SSU_1_EBV to SSU_16_EBV of the second touch group TG2 can be stored in the second area of the memory areas MA1 to MA16, and the effective touch sensing signals SSU_1_EBV to SSU_16_EBV of the third touch group can be stored in the third area of the memory areas MA1 to MA16, and the effective touch sensing signals SSU_1_EBV to SSU_16_EBV of the fourth touch group can be stored in the fourth area of the memory areas MA1 to MA16.

Here, the first area can mean four bits from the left of the memory area MA consisting of 16 bits, the second area can mean four bits provided on the right side of the first area, the third area can mean four bits provided on the right side of the second area, and the fourth area can mean four bits provided on the right side of the third area.

In this case, effective bit values corresponding to one effective touch sensing signal can consist of four bits.

To provide an additional description, when the touch electrodes TE are divided into A active groups (A is a natural number of 4 or more), and each of the A active groups includes B touch electrodes (B is a natural number of 2 or more), the touch detection part 700 can generate touch sensing signals by sequentially driving a first touch group to a kth touch group (k is a natural number of 3 or more). In this case, each of the first touch group to the k-th touch group can include at least two active groups.

The touch detection part 700 can store the B touch sensing signals generated in the first touch group in upper areas of the B memory areas, the touch detection part 700 can store the B touch sensing signals generated in the k-th touch group in lower areas of the B memory areas, and the touch detection part 700 can store the B touch sensing signals generated in the second touch group in the middle area of the B memory areas. The intermediate area can mean an area provided between the upper area and the lower area in each of the memory areas.

In the example described above with reference to FIG. 10, k can be 4, A can be 10, and B can be 16.

In this case, the first area can be an upper area, the fourth area can be a lower area, and each of the second area and the third area can be an intermediate area.

That is, in the display apparatus according to an embodiment of the present disclosure described above, the touch electrodes can be divided into A active groups (A is a natural number of 4 or more), and each of the A active groups can include B touch electrodes (B is a natural number of 2 or more).

In the active period, the touch detection part 700 can generate touch sensing signals by sequentially driving the A active groups, and in the touch detection period, the touch detection part 700 can generate D touch sensing signals by sequentially driving C touch groups (C is a natural number of 2 or more, and D is a natural number greater than B).

Each of the C touch groups TG can include at least two active groups AG, the touch detection part 700 can include B memory areas, and the touch detection part can store D touch sensing signals in B memory areas.

In this case, each of the B memory areas can include n bits.

In the touch detection period, the touch detection part 700 can generate an r1-th touch sensing signal by using touch electrode signals received from the r-th position touch electrodes (where r is a natural number less than or equal to B) included in the first touch group TG1, and can store m effective bit values among n measurement bit values constituting the r1-th touch sensing signal in the first area of the r-th memory area.

In the touch detection period, the touch detection part 700 can generate the r2-th touch sensing signal by using touch electrode signals received from the r-th position touch electrodes included in the second touch group TG2, and can store m effective bit values among n measurement bit values constituting the r2-th touch sensing signal in the second area of the r-th memory area.

Compared with a case where all measurement bit values constituting the touch sensing signal are stored in the memory 742, according to the present disclosure as described above, the memory 742 having a small size can be used. Therefore, the size of the display apparatus can be smaller, and the manufacturing cost of the display apparatus can be reduced.

The features of the display apparatus according to an embodiment of the present disclosure are briefly summarized as follows.

A display apparatus according to an embodiment of the present disclosure comprises a touch detection part supplying touch driving signals to touch electrodes provided in a display panel, and analyzing touch sensing signals generated by touch electrode signals received from the touch electrodes to detect touch on the display panel; and a touch control part for changing a driving period of the touch detection part to an active period for determining a touch coordinate or a touch detection period for detecting a touch based on whether the display panel is touched, wherein the touch detection part generates a touch sensing signal by using touch electrode signals received from at least two touch electrodes during the touch detection period, stores only effective bit values among measurement bit values constituting the touch sensing signal, and detects a touch on the display panel by using the effective bit values.

The touch detection part sets m measurement bit values among n measurement bit values constituting the touch sensing signal to the effective bit values (n is a natural number, and m is a natural number less than or equal to 1/2 of n).

The effective bit values include at least two upper area measurement bit values that affect the magnitude of the touch sensing signal among the measurement bit values.

The measurement bit values include an (n-1)th measurement bit value to a zero-th measurement bit value, and the effective bit values include a v-th measurement bit value to a w-th measurement bit value (v and w are natural numbers less than n, and w is a natural number less than v).

The touch detection part stores D touch sensing signals generated from all of the touch electrodes in B memory areas (D and B are natural numbers, and B is a natural number less than D) during the touch detection period.

The touch electrodes are divided into A active groups (A is a natural number of 4 or more), and each of the A active groups includes B touch electrodes (B is a natural number of 2 or more), in the touch detection period, the touch detection part sequentially drives C touch groups to generate touch sensing signals (C is a natural number of two or more), each of the C touch groups includes at least two active groups, and D is smaller than the number of touch electrodes provided in the display panel.

The touch detection part stores m upper area measurement bit values among n measurement bit values (n is a natural number and m is a natural number less than or equal to 1/2 of n) in a first area of the memory area.

The number of bits in the first area is smaller than the number of bits in the memory area.

The touch detection part generates at least two touch sensing signals in the touch detection period, each of the at least two touch sensing signals includes n measurement bit values, and among the at least two touch sensing signals, the touch detection part stores m measurement bit values among n measurement bit values of the first touch sensing signal and m measurement bit values among n measurement bit values of the second touch sensing signal in the first memory area.

The m measurement bit values of the first touch sensing signal are stored in an upper area of the first memory area, and the m measurement bit values of the second touch sensing signal are stored in a lower area of the first memory area.

The touch electrodes are divided into A active groups (A is a natural number of 4 or more), and each of the A active groups includes B touch electrodes (B is a natural number of 2 or more), in the touch detection period, the touch detection part sequentially drives C touch groups to generate touch sensing signals (C is a natural number of two or more), and each of the C touch groups includes at least two active groups.

The touch electrodes are divided into A active groups (A is a natural number of 4 or more), and each of the A active groups includes B touch electrodes (B is a natural number of 2 or more), in the touch detection period, the touch detection part sequentially drives a first touch group and a second touch group to generate touch sensing signals, each of the first touch group and the second touch group includes A/2 active groups, the touch detection part stores B touch sensing signals generated by the first touch group in upper areas of the B memory areas, and the touch detection part stores B touch sensing signals generated by the second touch group in lower areas of B memory areas.

The measurement bit values include an (n-1)th measurement bit value to a zero-th measurement bit value, the effective bit values include a v-th measurement bit value to a w-th measurement bit value (v and w are natural numbers less than n, and w is a natural number less than v), the touch detection part stores effective bit values of the B touch sensing signals generated in the first touch group in upper areas of the B memory areas, and the touch detection part stores effective bit values of the B touch sensing signals generated in the second touch group in lower areas of the B memory areas.

The touch electrodes are divided into A active groups (A is a natural number of 4 or more), and each of the A active groups includes B touch electrodes (B is a natural number of 2 or more), in the touch detection period, the touch detection part sequentially drives the first to k-th touch groups to generate touch sensing signals (k is a natural number of 3 or more), each of the first touch group to the kth touch group includes at least two active groups, the touch detection part stores B touch sensing signals generated by the first touch group in upper areas of B memory areas, the touch detection part stores B touch sensing signals generated by the k-th touch group in lower areas of B memory areas, the touch detection part stores B touch sensing signals generated by the second touch group in an intermediate area of the B memory areas, and the intermediate area is provided between the upper area and the lower area in each of the memory areas.

The touch electrodes are divided into A active groups (A is a natural number of 4 or more), and each of the A active groups includes B touch electrodes (B is a natural number of 2 or more), in the active period, the touch detection part sequentially drives the A active groups to generate touch sensing signals, in the touch detection period, the touch detection part sequentially drives C touch groups to generate D touch sensing signals (C is a natural number of 2 or more, and D is a natural number greater than B), each of the C touch groups includes at least two active groups, the touch detection part includes B memory areas, and the touch detection part stores the D touch sensing signals in the B memory areas.

Each of the B memory areas includes n bits, in the touch detection period, the touch detection part generates an r1-th touch sensing signal by using touch electrode signals received from r-th position touch electrodes (where r is a natural number less than or equal to B) included in the first touch group, and stores m effective bit values among n measurement bit values constituting the r1-th touch sensing signal in a first area of a r-th memory area, and in the touch detection period, the touch detection part generates an r2-th touch sensing signal by using touch electrode signals received from r-th position touch electrodes included in the second touch group, and stores m effective bit values among n measurement bit values constituting the r2-th touch sensing signal in a second area of the r-th memory area.

According to the display apparatus according to an embodiment of the present disclosure, the number of memory areas in which touch sensing signals are stored can be reduced.

Therefore, the area of a memory part including the memory areas can be reduced, and accordingly, miniaturization of the display apparatus can be achieved.

Also, according to the display apparatus according to an embodiment of the present disclosure, power consumption in the touch detection period, which determines only whether a touch occurs, can be reduced, and accordingly, power consumption of the display apparatus can be reduced.

The above-described feature, structure, and effect of the present disclosure are included in at least one embodiment of the present disclosure but are not limited to only one embodiment. Furthermore, the feature, structure, and effect described in at least one embodiment of the present disclosure can be implemented through combination or modification of other embodiments by those skilled in the art. Therefore, content associated with the combination and modification should be construed as being within the scope of the present disclosure.

It will be apparent to those skilled in the art that various modifications and variations can be made in the present disclosure without departing from the spirit or scope of the disclosures. Thus, it is intended that the present disclosure covers the modifications and variations of this disclosure provided they come within the scope of the present disclosure.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A display apparatus comprising:
a touch detection part supplying touch driving signals to touch electrodes provided in a display panel, and analyzing touch sensing signals generated by touch electrode signals received from the touch electrodes to detect touch on the display panel;
a touch control part for changing a driving period of the touch detection part to an active period for determining a touch coordinate or a touch detection period for detecting a touch based on whether the display panel is touched; and
a memory comprising a plurality of memory areas,
wherein the touch detection part generates a touch sensing signal by using touch electrode signals received from at least two touch electrodes during the touch detection period, stores only effective bit values among measurement bit values constituting the touch sensing signal, and detects a touch on the display panel by using the effective bit values.

2. The display apparatus of claim 1, wherein the touch detection part sets m measurement bit values among n measurement bit values constituting the touch sensing signal to the effective bit values, and
wherein n is a natural number, and m is a natural number less than or equal to 1/2 of n.

3. The display apparatus of claim 1, wherein
the effective bit values include at least two upper area measurement bit values that affect the magnitude of the touch sensing signal among the measurement bit values.

4. The display apparatus of claim 1, wherein the measurement bit values include an (n-1)th measurement bit value to a zero-th measurement bit value,
wherein the effective bit values include a v-th measurement bit value to a w-th measurement bit value, and
wherein v and w are natural numbers less than n, and w is a natural number less than v.

5. The display apparatus of claim 1, wherein the touch detection part stores D touch sensing signals generated from all of the touch electrodes in B memory areas of the memory during the touch detection period, and
wherein D and B are natural numbers, and B is a natural number less than D.

6. The display apparatus of claim 5, wherein:
the touch electrodes are divided into A active groups, and each of the A active groups includes B touch electrodes,
in the touch detection period, the touch detection part sequentially drives C touch groups to generate touch sensing signals,
each of the C touch groups includes at least two active groups,
D is smaller than the number of touch electrodes provided in the display panel
A is a natural number of 4 or more,
B is a natural number of 2 or more, and
C is a natural number of two or more.

7. The display apparatus of claim 1, wherein
the touch detection part stores m upper area measurement bit values among n measurement bit values in a first area of a memory area among the plurality of memory areas, and
n is a natural number and m is a natural number less than or equal to 1/2 of n.

8. The display apparatus of claim 7, wherein
the number of bits in the first area is smaller than the number of bits in the memory area.

9. The display apparatus of claim 1, wherein
the touch detection part generates at least two touch sensing signals in the touch detection period,
each of the at least two touch sensing signals includes n measurement bit values, and
among the at least two touch sensing signals, the touch detection part stores m measurement bit values among n measurement bit values of a first touch sensing signal and m measurement bit values among n measurement bit values of a second touch sensing signal in a first memory area among the plurality of memory areas.

10. The display apparatus of claim 9, wherein
the m measurement bit values of the first touch sensing signal are stored in an upper area of the first memory area, and
the m measurement bit values of the second touch sensing signal are stored in a lower area of the first memory area.

11. The display apparatus of claim 1, wherein
the touch electrodes are divided into A active groups, and each of the A active groups includes B touch electrodes,
in the touch detection period, the touch detection part sequentially drives C touch groups to generate touch sensing signals, and each of the C touch groups includes at least two active groups,
A is a natural number of 4 or more,
B is a natural number of 2 or more, and
C is a natural number of two or more.

12. The display apparatus of claim 1, wherein
the touch electrodes are divided into A active groups (A is a natural number of 4 or more), and each of the A active groups includes B touch electrodes (B is a natural number of 2 or more),
in the touch detection period, the touch detection part sequentially drives a first touch group and a second touch group to generate touch sensing signals,
each of the first touch group and the second touch group includes A/2 active groups,
the touch detection part stores B touch sensing signals generated by the first touch group in upper areas of B memory areas of the memory, and
the touch detection part stores B touch sensing signals generated by the second touch group in lower areas of B memory areas.

13. The display apparatus of claim 12, wherein
the measurement bit values include an (n-1)th measurement bit value to a zero-th measurement bit value,
the effective bit values include a v-th measurement bit value to a w-th measurement bit value (v and w are natural numbers less than n, and w is a natural number less than v),
the touch detection part stores effective bit values of the B touch sensing signals generated in the first touch group in upper areas of the B memory areas, and
the touch detection part stores effective bit values of the B touch sensing signals generated in the second touch group in lower areas of the B memory areas.

14. The display apparatus of claim 1, wherein
the touch electrodes are divided into A active groups (A is a natural number of 4 or more), and each of the A active groups includes B touch electrodes (B is a natural number of 2 or more),
in the touch detection period, the touch detection part sequentially drives the first to k-th touch groups to generate touch sensing signals (k is a natural number of 3 or more),
each of the first touch group to the kth touch group includes at least two active groups,
the touch detection part stores B touch sensing signals generated by the first touch group in upper areas of B memory areas of the memory,
the touch detection part stores B touch sensing signals generated by the k-th touch group in lower areas of B memory areas,
the touch detection part stores B touch sensing signals generated by the second touch group in an intermediate area of the B memory areas, and
the intermediate area is provided between the upper area and the lower area in each of the memory areas.

15. The display apparatus of claim 1, wherein
the touch electrodes are divided into A active groups (A is a natural number of 4 or more), and each of the A active groups includes B touch electrodes (B is a natural number of 2 or more),
in the active period, the touch detection part sequentially drives the A active groups to generate touch sensing signals,
in the touch detection period, the touch detection part sequentially drives C touch groups to generate D touch sensing signals (C is a natural number of 2 or more, and D is a natural number greater than B),
each of the C touch groups includes at least two active groups,
the touch detection part includes B memory areas of the memory, and
the touch detection part stores the D touch sensing signals in the B memory areas.

16. The display apparatus of claim 15, wherein
each of the B memory areas includes n bits,
in the touch detection period, the touch detection part generates an r1-th touch sensing signal by using touch electrode signals received from r-th position touch electrodes (where r is a natural number less than or equal to B) included in a first touch group, and stores m effective bit values among n measurement bit values constituting the r1-th touch sensing signal in a first area of a r-th memory area, and
in the touch detection period, the touch detection part generates an r2-th touch sensing signal by using touch electrode signals received from r-th position touch electrodes included in a second
touch group, and stores m effective bit values among n measurement bit values constituting the r2-th touch sensing signal in a second area of the r-th memory area.
